(19) United States
(12) Patent Application Publication
(10) Pub. No.: US 2017/0067433 A1
(43) Pub. Date: Mar. 9, 2017

(54) IDLE STOP CONTROL SYSTEM AND METHOD

(71) Applicant: MANDO CORPORATION, Pyeongtaek-si (KR)

(72) Inventor: Hee Rak AHN, Seongnam-si (KR)

(21) Appl. No.: 15/257,881

(22) Filed: Sep. 6, 2016

(30) Foreign Application Priority Data
Sep. 7, 2015 (KR) 10-2015-0126410

(51) Int. Cl. F02N 11/08

(52) U.S. Cl. CPC F02N 11/0837; F02N 11/0829; F02N 11/084; F02N 2200/023; F02N 2200/04; F02N 2200/0801; F02N 2200/0807; F02N 2200/0809; F02N 2200/102; F02N 2200/125; F02N 2200/123; F02N 2200/14; F02N 2300/306; F02N 2300/304

(57) ABSTRACT

Disclosed herein is an idle stop control system including an information collection unit, a signal processing unit, and an engine control unit. The information collection unit collects information about idle stop control of an engine. The signal processing unit checks whether or not to satisfy a condition of idle stop control based on the information about idle stop control, and estimates a first cost loss incurred when a start-up state is maintained for an expected time of idle stop, and a second cost loss incurred during restart after the expected time of idle stop. The engine control unit controls an idle stop of the engine when the second cost loss is less than the first cost loss.

### CROSS-REFERENCE(S) TO RELATED APPLICATIONS

This application claims priority to Korean Patent Application No. 10-2015-0126410, filed on Sep. 7, 2015, the disclosure of which is incorporated herein by reference in its entirety.

### BACKGROUND OF THE INVENTION

Field of the Invention

Exemplary embodiments of the present invention relate to an idle stop control system and method, and more particularly, aim to control an idle stop using traffic light information and a stopping position. That is, the present invention relates to an idle stop control system and method capable of controlling an idle stop with high economic efficiency by comparing a fuel economy cost expected during the idle stop with an additional cost incurred during restart.

Description of the Related Art

For vehicles having eco-friendliness and high fuel-efficiency according to high oil prices and environmental regulations, an ISG (Idle Stop and Go) system, in which an engine is automatically stopped when it satisfies a certain condition set in an idle state and the engine is restarted when a starting intention is detected, receives attention as a key technology.

Such an ISG system may improve fuel efficiency by idle-stopping an engine when the engine is maintained in an idle state for a certain time.

By way of example, Korean Patent Laid-open Publication No. 10-2015-0071440 discloses a method of improving a fuel efficiency of 5% or more when a vehicle travels in the congested sections in downtown by allowing the vehicle to enter an idle stop mode from when it travels at a speed less than 30 km/h.

However, the method does not consider economic feasibility between a fuel cost saved during the idle stop and an addition cost incurred during restart, and hence there is a problem in that the efficiency of an IGS system is reduced.

[Patent Document] Korean Patent Laid-open Publication No. 10-2015-0071440 (Jun. 26, 2015)

### SUMMARY OF THE INVENTION

An object of the present invention is to provide an idle stop control system and method capable of controlling an idle stop using traffic light information and a stopping position.

Another object of the present invention is to provide an idle stop control system and method capable of controlling an idle stop with high economic efficiency by comparing a fuel economy cost expected during the idle stop with an additional cost incurred during restart, and efficiently determining whether or not to control the idle stop.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with one aspect of the present invention, an idle stop control system includes an information collection unit, a signal processing unit, and an engine control unit. The information collection unit collects information about idle stop control of an engine. The signal processing unit checks whether or not to satisfy a condition of idle stop control based on the information about idle stop control, and estimates a first cost loss incurred when a start-up state is maintained for an expected time of idle stop, and a second cost loss incurred during restart after the expected time of idle stop. The engine control unit controls an idle stop of the engine when the second cost loss is less than the first cost loss.

The information collection unit may include at least one of a traffic information collection unit to collect traffic information, a vehicle information collection unit to collect vehicle information, and an idle stop control condition information collection unit to collect information about the condition of idle stop control.

The traffic information collection unit may include at least one of a traffic congestion information collection unit to collect traffic congestion information, and a traffic light information collection unit to collect traffic light information.

The vehicle information collection unit may include at least one of an engine information collection unit to collect engine information including at least one of an engine temperature and fuel consumption during start-up, a battery information collection unit to collect battery information including at least one of a battery replacement cost and the number of times of limited start-up, a starter motor information collection unit to collect starter motor information including at least one of the number of times of limited start-up and a starter motor replacement cost, and a turn signal information collection unit to collect turn signal information.

The idle stop control condition information collection unit may include at least one of a brake booster pressure collection unit to collect a brake booster pressure, a battery charge state collection unit to collect a state of charge of a battery, an electrical load collection unit to collect an electrical load, a vehicle speed collection unit to collect a vehicle speed, and a brake pedal state collection unit to collect a brake pedal state.

The signal processing unit may include an idle stop condition determination unit to determine whether to satisfy a condition of idle stop, based on a brake booster pressure, a state of charge of a battery, an electrical load, a vehicle speed, and a brake pedal state.

The idle stop condition determination unit may determine that the condition of idle stop is satisfied when the brake booster pressure is higher than a reference value, when the state of charge of a battery is higher than a reference value, when the electrical load is lower than a reference value, when the vehicle speed is 0 km/h, and when the brake pedal is pressed.

The signal processing unit may include a cost estimation unit to estimate an integration cost based on input pieces of information. The cost estimation unit may include at least one of a fuel cost estimation unit to estimate a fuel cost based on at least one of an engine temperature and fuel consumption during start-up, a battery cost estimation unit to estimate a battery cost based on at least one of a battery replacement cost and the number of times of limited start-up, a starter motor cost estimation unit to estimate a starter motor cost based on at least one of the number of times of limited start-up and a starter motor replacement cost, and an engine cost estimation unit to estimate an engine cost based on at least one of an engine stop time, an engine temperature, a torque required to start an engine, and an engine replacement cost.

The cost estimation unit may include an idle stop duration estimation unit to estimate a time for which an idle stop is maintained, based on at least one of a turn signal, traffic congestion information, traffic light information, and a distance between a traffic light and a vehicle.

The cost estimation unit may include an integration cost estimation unit to estimate an integration cost, based on output from at least one of the fuel cost estimation unit, the battery cost estimation unit, the starter motor cost estimation unit, the engine cost estimation unit, and the idle stop duration estimation unit.

The signal processing unit may estimate the expected time of idle stop by matching one of directions of progress in a turn signal or a navigation system with traffic light information.

When one of directions of progress in a turn signal or a navigation system indicates a right-turn, the signal processing unit may not control the idle stop.

When one of directions of progress in a turn signal or a navigation system indicates a left-turn, the signal processing unit may estimate the expected time of idle stop on the basis of a short one of times required to make left- and U-turns.

The signal processing unit may increase the expected time of idle stop when there is heavy traffic.

The signal processing unit may increase the expected time of idle stop in proportion to a distance between a traffic light and a vehicle.

In accordance with another aspect of the present invention, an idle stop control method includes checking whether to satisfy a condition of idle stop control, collecting information about idle stop control, estimating cost efficiency for an expected time of idle stop, checking whether a cost-benefit is present during an idle stop, and controlling an idle stop of an engine only when the cost-benefit is present.

The idle stop control method may include estimating a first cost loss incurred when a start-up state is maintained for the expected time of idle stop, and a second cost loss incurred during restart after the expected time of idle stop. The idle stop control method may include controlling the idle stop of the engine when the second cost loss is less than the first cost loss.

The idle stop control method may include estimating the expected time of idle stop, based on at least one of a turn signal, traffic congestion information, traffic light information, and a distance between a traffic light and a vehicle.

The idle stop control method may include estimating the expected time of idle stop by matching one of directions of progress in the turn signal or a navigation system with the traffic light information, or estimating the expected time of idle stop on the basis of a short one of times required to make left- and U-turns, when one of the directions of progress in the turn signal or the navigation system indicates a left-turn.

The idle stop control method may include estimating a fuel cost based on at least one of an engine temperature and fuel consumption during start-up. The idle stop control method may include estimating a battery cost based on at least one of a battery replacement cost and the number of times of limited start-up. The idle stop control method may include estimating a starter motor cost based on at least one of the number of times of limited start-up and a starter motor replacement cost. The idle stop control method may include estimating an engine cost based on at least one of an engine stop time, an engine temperature, a torque required to start an engine, and an engine replacement cost.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an idle stop control system according to an embodiment of the present invention;

FIG. 2 is a graph illustrating costs estimated by a signal processing unit of FIG. 1 in detail;

FIG. 3 is a block diagram illustrating an information collection unit of FIG. 1 in detail;

FIG. 4 is a block diagram illustrating a traffic information collection unit of FIG. 3 in more detail;

FIG. 5 is a block diagram illustrating a vehicle information collection unit of FIG. 3 in more detail;

FIG. 6 is a block diagram illustrating an idle stop control condition information collection unit of FIG. 3 in more detail;

FIG. 7 is a block diagram illustrating the signal processing unit of FIG. 1 in detail;

FIG. 8 is a block diagram illustrating a cost estimation unit of FIG. 7 in more detail;

FIG. 9 is a view illustrating traffic information collected by the information collection unit of FIG. 1; and

FIG. 10 is a flowchart illustrating an idle stop control method according to another embodiment of the present invention.

### DESCRIPTION OF SPECIFIC EMBODIMENTS

Exemplary embodiments of the present invention will be described below in more detail with reference to the accompanying drawings so as to be realized by a person of ordinary skill in the art. The present invention may, however, be embodied in different forms and should not be construed as limited to the embodiments set forth herein.

In certain embodiments, description irrelevant to the present invention may be omitted to avoid obscuring appreciation of the disclosure. Throughout the disclosure, like reference numerals refer to like parts throughout the various figures and embodiments of the present invention.

In the whole description, it will be understood that when an element is referred to as being “connected” to another element, it can be “directly connected” to the other element or it can be “electrically connected” to the other element with other elements being interposed therebetween. In addition, it will be understood that when a component is referred to as being “comprising” any component, it does not exclude other components, but can further comprises the other components unless otherwise specified.

It will be understood that when an element is referred to as being “above” another element, it can be immediately above the other element or intervening elements may also be present. In contrast, when an element is referred to as being “immediately above” another element, there are no intervening elements present.

Although terms such as first, second, and third are used to describe various parts, components, regions, layers, and/or sections, the present invention is not limited thereto. Such terms will be used only to differentiate one part, component, region, layer, or section from other parts, components, regions, layers, or sections. Accordingly, a first part, component, region, layer, or section may be referred to as a second part, component, region, layer, or section without deviating from the scope and spirit of the present invention.

The terminology used in the specification of the present invention is for the purpose of describing particular embodiments only and is not intended to limit the invention. As used in the specification and the appended claims, the singular forms are intended to include the plural forms as well, unless context clearly indicates otherwise. It will be further understood that the terms “comprises” and/or “comprising,” when used in this specification, specify the presence of stated features, regions, integers, steps, operations, elements, and/or components, but do not preclude the presence or addition of one or more other features, regions, integers, steps, operations, elements, and/or components thereof.

Spatially-relative terms such as “below”, “above”, or the like may be used herein to describe one element's relationship to another element as illustrated in the Figures. It will be understood that spatially-relative terms are intended to encompass different orientations of the device in addition to the orientation depicted in the Figures. For example, if the device in one of the figures is turned over, elements described as “below” other elements would then be oriented “above” the other elements. The exemplary terms “below” can, therefore, encompass both an orientation of above and below. Since the device may be oriented in another direction such as rotation of 90° or another angle, the spatially-relative terms may be interpreted in accordance with the orientation of the device.

Unless otherwise defined, all terms, including technical and scientific terms, used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary embodiments of the present invention will be described in more detail with reference to the accompanying drawings so as to be realized by a person of ordinary skill in the art. The present invention may, however, be embodied in different forms and should not be construed as limited to the embodiments set forth herein.

Reference will now be made in detail to an idle stop control system and method according to exemplary embodiments of the present invention, examples of which are illustrated in the accompanying drawings.

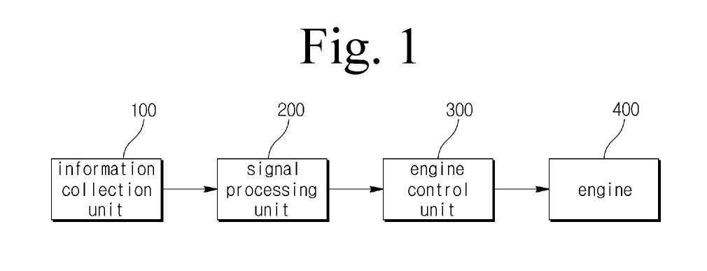

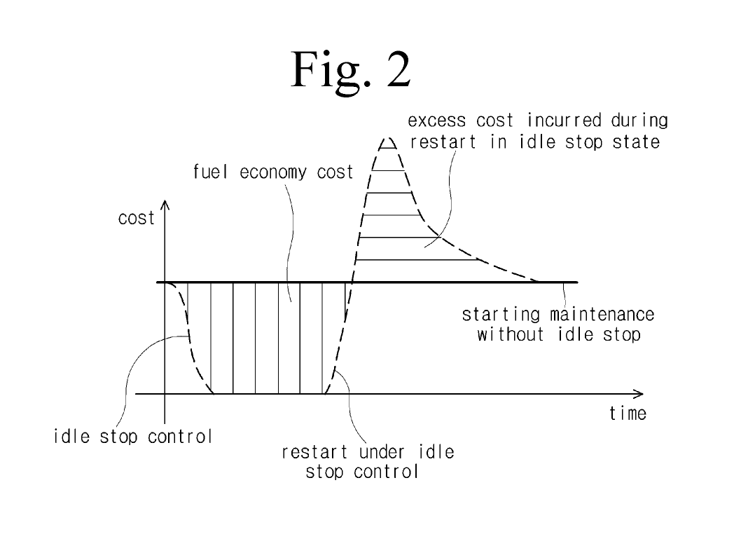

FIG. 1 is a block diagram illustrating an idle stop control system according to an embodiment of the present invention. FIGS. 2 to 9 are a graph, block diagrams, and a view for depicting FIG. 1 in detail.

Hereinafter, the idle stop control system according to the embodiment of the present invention will be described with reference to FIGS. 1 to 9.

First, referring to FIG. 1, the idle stop control system according to the embodiment of the present invention includes an information collection unit 100, a signal processing unit 200, and an engine control unit 300.

The information collection unit 100 collects information about idle stop control of an engine 400. The signal processing unit 200 checks whether or not to satisfy a condition of idle stop control based on the information about idle stop control. In addition, the signal processing unit 200 estimates a first cost loss incurred when the engine is maintained in a started state for a T time as an expected time of idle stop, and a second cost loss incurred when the engine is started after the T time. When the second cost loss is less than the first cost loss, the engine control unit 300 controls the idle stop of the engine 400.

That is, the information collection unit 100 may collect the information about idle stop control of the engine 400, and the signal processing unit 200 may estimate various cost losses based on the information about idle stop control for the T time.

In addition, the signal processing unit 200 may estimate the expected time of idle stop based on a traffic light, a distance from the traffic light, a turn signal, an expected direction of progress indicated by a navigation system, and traffic congestion information. In addition, the signal processing unit 200 may estimate various cost losses for the expected time of idle stop. Therefore, it is possible to enhance cost efficiency by comparing these cost losses and controlling the idle stop.

FIG. 2 is a graph illustrating costs estimated by the signal processing unit of FIG. 1 in detail.

Referring to FIG. 2, when a fuel economy cost is greater than the cost incurred during restart under the idle stop control, it may be efficient that the idle stop control is not performed. Accordingly, it is possible to efficiently control the idle stop of the engine by comparing the fuel economy cost with the excess cost incurred during restart under the idle stop control.

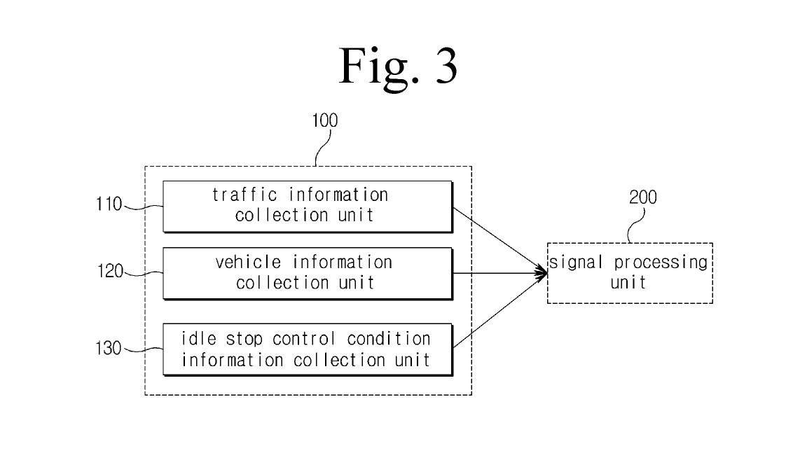

FIG. 3 is a block diagram illustrating the information collection unit of FIG. 1 in detail.

Referring to FIG. 3, the information collection unit 100 may include at least one of a traffic information collection unit 110 which collects traffic information, a vehicle information collection unit 120 which collects vehicle information, and an idle stop control condition information collection unit 130 which collects information about a condition of idle stop control.

That is, the traffic information collection unit 110 collects traffic congestion information, traffic light information, etc. and provides them to the signal processing unit 200. This enables the signal processing unit 200 to estimate the expected time of idle stop of a vehicle.

In addition, the vehicle information collection unit 120 provides engine information including an engine temperature and fuel consumption during start-up, battery information including a battery replacement cost and the number of times of limited start-up, starter motor information including the number of times of limited start-up and a starter motor replacement cost, and turn signal information, to the signal processing unit 200. Accordingly, it is possible to increase the accuracy of the expected time of idle stop and estimate costs incurred during restart after the idle stop.

Meanwhile, the idle stop control condition information collection unit 130 provides a brake booster pressure, a state of charge of a battery, an electrical (electronic device) load, a vehicle speed, and a brake pedal state, to the signal processing unit 200. This enables the signal processing unit 200 to determine whether to satisfy a condition of idle stop control.

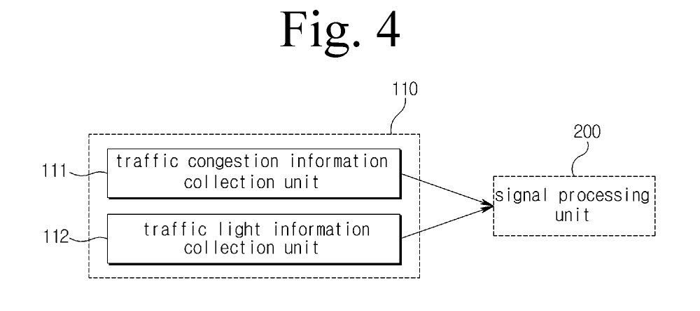

FIG. 4 is a block diagram illustrating the traffic information collection unit of FIG. 3 in more detail.

Referring to FIG. 4, the traffic information collection unit 110 may include at least one of a traffic congestion information collection unit 111 and a traffic light information collection unit 112.

That is, the traffic congestion information collection unit 111 collects traffic congestion information and provides it to the signal processing unit 200. This enables the signal processing unit 200 to adjust the expected time of idle stop depending on the level of traffic congestion.

For example, since the time of departure of a vehicle may be delayed when the level of traffic congestion is heavier than before, the signal processing unit 200 increases the expected time of idle stop.

In addition, the traffic light information collection unit 112 collects traffic light information and provides it to the signal processing unit 200. In this case, the traffic light information collection unit 112 collects the lighting schedule of a traffic light through wireless transmission and reception from a traffic light management server, and provides the collected traffic light information to the signal processing unit 200. This enables the signal processing unit 200 to adjust the expected time of idle stop. In this case, the present invention has an advantage of recognizing a traffic light state without cameras.

In addition, the traffic information collection unit 110 calculates a distance between the traffic light and the vehicle through communication with the traffic light management server or using a GPS, and transmits information about the distance between the traffic light, together with the traffic congestion information and the traffic light information, to the signal processing unit 200. This enables the signal processing unit 200 to accurately estimate the expected time of idle stop.

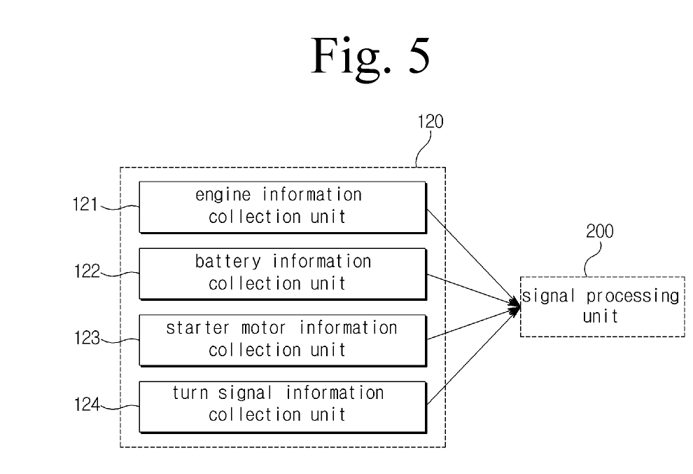

FIG. 5 is a block diagram illustrating the vehicle information collection unit of FIG. 3 in more detail.

Referring to FIG. 5, the vehicle information collection unit 120 includes an engine information collection unit 121, a battery information collection unit 122, a starter motor information collection unit 123, and turn signal information collection unit 124.

The engine information collection unit 121 collects engine information including an engine temperature and fuel consumption during start-up, and provides the collected engine information to the signal processing unit 200. In addition, the engine information collection unit 121 provides the engine temperature, the fuel consumption during start-up, etc. to the signal processing unit 200 in order to estimate costs incurred in the engine during restart after the idle stop.

The battery information collection unit 122 collects battery information including a battery replacement cost and the number of times of limited start-up, and provides the collected battery information to the signal processing unit 200. In addition, the battery information collection unit 122 may provide information about a state of charge of a battery and a battery temperature to the signal processing unit 200. This enables the signal processing unit 200 to estimate costs incurred in a battery during restart after the idle stop.

The starter motor information collection unit 123 collects starter motor information including the number of times of limited start-up and a starter motor replacement cost, and provides the collected starter motor information to the signal processing unit 200. In addition, the starter motor information collection unit 123 may provide information about the number of times a starter motor may start an engine, and information about the starter motor replacement cost, to the signal processing unit 200. This enables the signal processing unit 200 to estimate costs incurred in the starter motor during restart after idle stop.

The turn signal information collection unit 124 collects turn signal information, and provides the collected turn signal information to the signal processing unit 200. This enables the signal processing unit 200 to accurately estimate the expected time of idle stop.

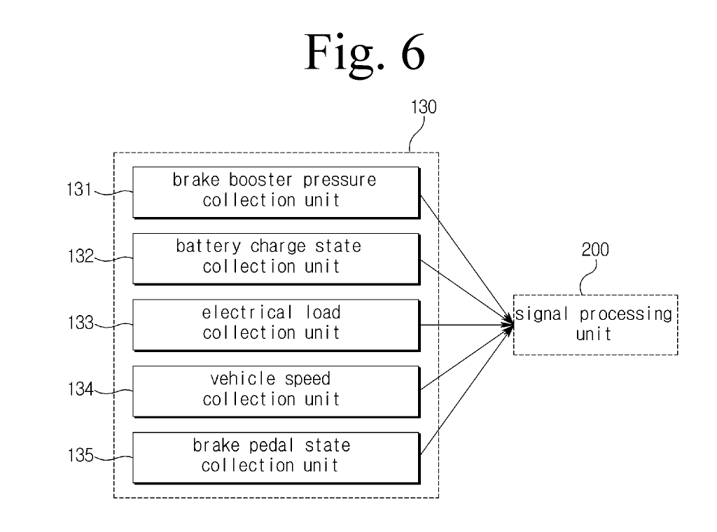

FIG. 6 is a block diagram illustrating the idle stop control condition information collection unit 130 of FIG. 3 in more detail.

Referring to FIG. 6, the idle stop control condition information collection unit 130 may include at least one of a brake booster pressure collection unit 131, a battery charge state collection unit 132, an electrical load collection unit 133, a vehicle speed collection unit 134, and a brake pedal state collection unit 135.

The brake booster pressure collection unit 131 collects a brake booster pressure, and provides the collected brake booster pressure to the signal processing unit 200. If the idle stop of the engine 400 is controlled when the brake booster pressure is lower than a reference value, the performance of operation of a brake may be markedly deteriorated. Thus, the brake booster pressure collection unit 131 provides the brake booster pressure to the signal processing unit 200 such that the idle stop is controlled when the brake booster pressure is higher than the reference value.

The battery charge state collection unit 132 collects information about a state of charge of a battery, and provides it to the signal processing unit 200. If the idle stop of the engine 400 is controlled when the state of charge of a battery is lower than a reference value, the electrical performance of the vehicle may be adversely affected. Thus, the battery charge state collection unit 132 provides the information about a state of charge of a battery to the signal processing unit 200 such that the idle stop is controlled when the state of charge of a battery is higher than the reference value.

The electrical load collection unit 133 collects an electrical load, and provides the collected electrical load to the signal processing unit 200. If the idle stop of the engine 400 is controlled when the load of electrical equipment such as an air conditioner is higher than a reference value, electric power may not be supplied from the battery to a load corresponding to the load of electrical equipment. Hence, if electric power is not supplied to the load, the electrical performance of the vehicle may be adversely affected. Thus, the electrical load collection unit 133 may provide the electrical load to the signal processing unit 200 such that the idle stop is controlled when the electrical load is lower than a reference value.

The vehicle speed collection unit 134 may provide a vehicle speed to the signal processing unit 200, in which case the condition of idle stop control of the engine 400 is not satisfied when the vehicle speed is not 0 km/h. That is, the vehicle speed collection unit 134 may detect a vehicle speed and provide it to the signal processing unit 200, in which case the condition of idle stop control is satisfied when the vehicle speed is 0 km/h.

Meanwhile, the brake pedal state collection unit 135 collects brake state information, and provides it to the signal processing unit 200. The brake pedal state collection unit 135 provides the brake state information to the signal processing unit 200, in which case the condition of idle stop control of the engine 400 is not satisfied when a brake pedal is not pressed. That is, the brake pedal state collection unit 135 detects brake pedal state information, and provides the brake pedal state information to the signal processing unit 200, in which case the condition of idle stop control is satisfied when the brake pedal is pressed.

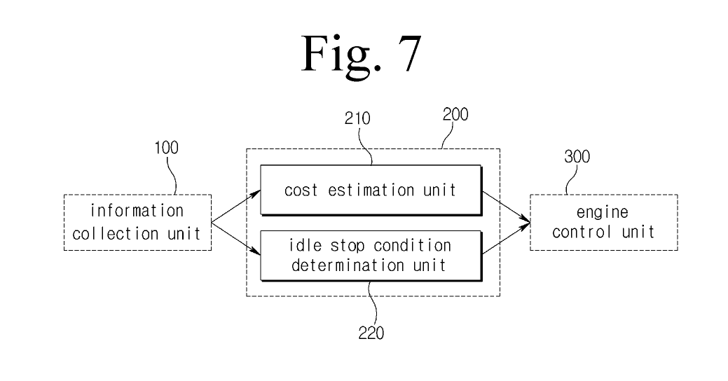

FIG. 7 is a block diagram illustrating the signal processing unit 200 of FIG. 1 in detail.

Referring to FIG. 7, the signal processing unit 200 includes a cost estimation unit 210 and an idle stop condition determination unit 220

The cost estimation unit 210 estimates an integration cost based on input pieces of information.

The idle stop condition determination unit 220 determines that the condition of idle stop is satisfied when the brake booster pressure is higher than a reference value, when the state of charge of a battery is higher than a reference value, when the electrical load is lower than a reference value, when the vehicle speed is 0 km/h, and when the brake pedal is pressed (a pressure is applied thereto).

The signal processing unit 200 estimates a time for which an idle stop is maintained, and compares a fuel economy cost for the estimated time with a cost, which is additionally incurred during restart after the idle stop, based on a fuel cost, a battery cost, a starter motor cost, and an engine cost. Accordingly, it is possible to estimate the integration cost based on the result of comparison.

In addition, the signal processing unit 200 may check the condition of idle stop based on the brake booster pressure, the state of charge of a battery, the vehicle speed, and the brake pedal state.

The signal processing unit 200 transmits the integration cost and the condition of idle stop to the engine control unit 300, so that the idle stop control is performed.

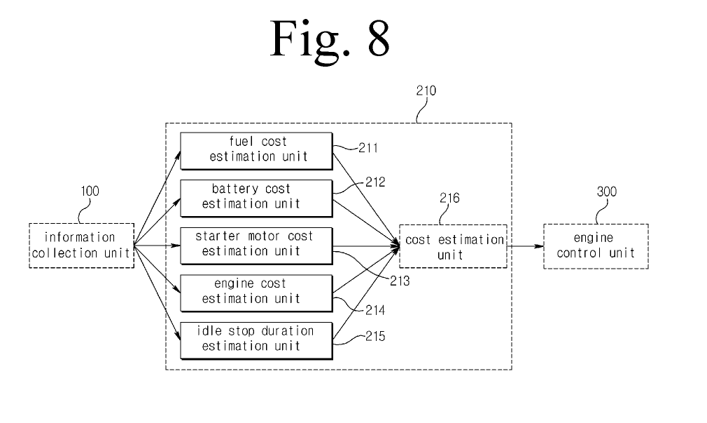

FIG. 8 is a block diagram illustrating the cost estimation unit 210 of FIG. 7 in more detail.

Referring to FIG. 8, the cost estimation unit 210 includes at least one of a fuel cost estimation unit 211, a battery cost estimation unit 212, a starter motor cost estimation unit 213, an engine cost estimation unit 214, and an idle stop duration estimation unit 215.

A longer idle stop time may result in a decrease in engine temperature, and a lot of fuel may be consumed when the engine temperature is lower than a reference value. The fuel cost estimation unit 211 estimates a fuel cost based on at least one of an engine temperature and fuel consumption during start-up. In addition, since an engine rpm is rapidly increased when the engine 400 is started rather than when idling, a lot of fuel may be consumed. Accordingly, the fuel cost estimation unit 211 estimates the fuel cost based on at least one of the engine temperature and the fuel consumption during start-up.

The more the number of times of start-up, the faster the replacement cycle of a battery. Also, the battery is discharged quickly as the number of times of start-up is increased. Hence, a lot of fuel is consumed to recharge the battery. Accordingly, the battery cost estimation unit 212 estimates a battery cost based on at least one of a battery replacement cost and the number of times of limited start-up.

The more the number of times of start-up, the faster the replacement cycle of a starter motor. Therefore, the starter motor cost estimation unit 213 estimates a starter motor cost based on at least one of the number of times of limited start-up and a starter motor replacement cost.

In addition, the lower an engine temperature or the larger a torque required to start an engine, the faster the deterioration of the engine. The engine cost estimation unit 214 estimates an engine cost based on at least one of an engine stop time, an engine temperature, a torque required to start an engine, and an engine replacement cost. The more the number of times of start-up, the faster the replacement cycle of an engine. Also, a longer engine stop time may result in the faster deterioration of the engine since its abrasion occurs due to a lack of engine oil. Accordingly, the engine cost estimation unit 214 estimates the engine cost by reflecting the same.

The idle stop duration estimation unit 215 estimates a time for which an idle stop is maintained, based on at least one of a turn signal, traffic congestion information, traffic light information, and a distance between the traffic light and the vehicle. For example, it is possible to independently check information about lighting of the traffic light from the direction indicated by the turn signal or navigation system, to estimate a possible departure time after the traffic light is lighted, with consideration of the distance between the traffic light and the vehicle, and to delay the possible departure time when there is heavy traffic, based on the traffic congestion information.

In addition, the cost estimation unit 210 may include an integration cost estimation unit 216. The integration cost estimation unit 216 may estimate an integration cost based on output from at least one of the fuel cost estimation unit 211, the battery cost estimation unit 212, the starter motor cost estimation unit 213, the engine cost estimation unit 214, and the idle stop duration estimation unit 215.

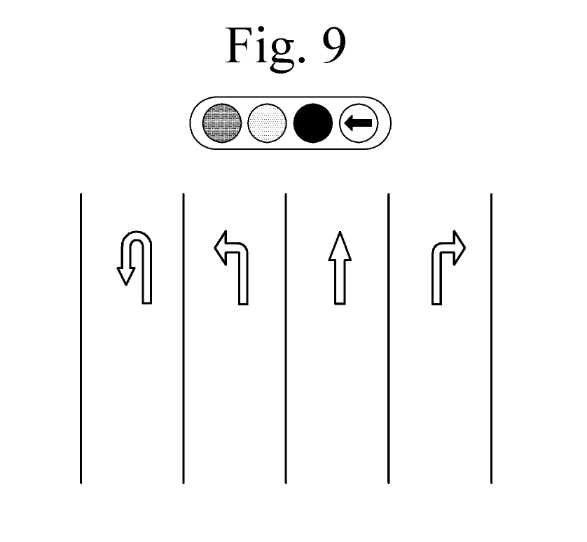

FIG. 9 is a view illustrating traffic information collected by the information collection unit 100 of FIG. 1.

Referring to FIG. 9, the signal processing unit 200 may estimate an expected time of idle stop by matching one of the directions of progress in the turn signal or navigation system with the traffic light information.

In addition, when one of the directions of progress in the turn signal or navigation system indicates a right-turn, the signal processing unit 200 may not control an idle stop.

Here, when one of the directions of progress in the turn signal or navigation system indicates a left-turn, the signal processing unit 200 may estimate the expected time of idle stop on the basis of a short one of times required to make left- and U-turns.

In addition, the signal processing unit 200 may increase the expected time of idle stop when there is heavy traffic.

Meanwhile, the signal processing unit 200 may increase the expected time of idle stop in proportion to the distance between the traffic light and the vehicle.

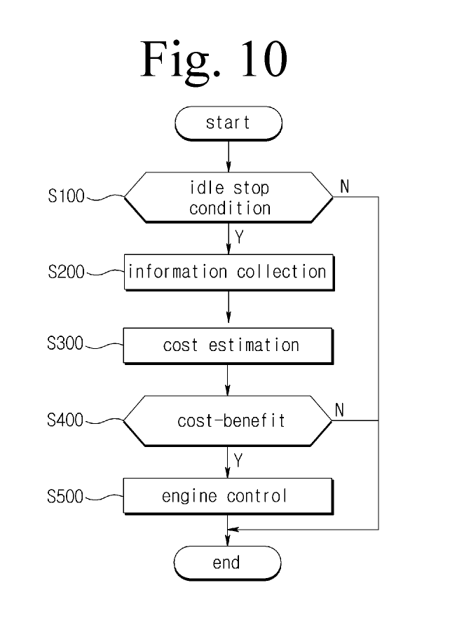

FIG. 10 is a flowchart illustrating an idle stop control method according to another embodiment of the present invention. The idle stop control method will be described with reference to FIG. 10.

First, the method performs an idle stop condition check step (S100) of checking whether to satisfy a condition of idle stop control.

Next, the method performs an information collection step (S200) of collecting information about idle stop control.

Next, the method performs a cost estimation step (S300) of estimating cost efficiency for an expected time of idle stop.

Next, the method performs a cost-benefit check step (S400) of checking whether a cost-benefit is present during an idle stop.

Next, the method performs an engine control step (S500) of controlling the idle stop of an engine 400 only when the cost-benefit is present.

Here, in the cost estimation step (S300), a fuel cost is estimated based on at least one of an engine temperature and fuel consumption during start-up, with respect to a time for which an idle stop is maintained based on at least one of a turn signal, traffic congestion information, traffic light information, and a distance between a traffic light and a vehicle. A battery cost is estimated based on at least one of a battery replacement cost and the number of times of limited start-up. A starter motor cost is estimated based on at least one of the number of times of limited start-up and a starter motor replacement cost. An engine cost is estimated based on at least one of an engine stop time, an engine temperature, a torque required to start an engine, and an engine replacement cost.

As is apparent from the above description, an idle stop control system and method according to exemplary embodiments of the present invention can control an idle stop using traffic light information and a stopping position.

In addition, the idle stop control system and method can control the idle stop with high economic efficiency by comparing a fuel economy cost expected during the idle stop with an additional cost incurred during restart. Thus, it is possible to efficiently determine whether or not to control the idle stop.

The present invention is not limited to the foregoing effects, and other effects thereof will be clearly understood by those skilled in the art from the above description and the following claims.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

In one or more exemplary embodiments, the functions of the present application may be implemented by hardware, software, firmware, or any combination thereof. When implemented in software, these functions may be stored or transmitted as one or more instructions or codes on computer-readable media. The computer-readable media may include both computer storage media and communication media including any medium that facilitates transfer of a computer program from one place to another place. The storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, when software is transmitted from websites, servers, or other remote sources using coaxial cables, fiber optic cables, twisted pairs, digital subscriber line (DSL), or wireless technologies, such as infrared, radio, and microwaves, the coaxial cables, fiber optic cables, twisted pairs, DSL, or wireless technologies, such as infrared, radio, and microwaves, are included in the definition of media. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of them should also be included within the scope of computer-readable media.

Furthermore, when embodiments are implemented with program code or code segments, a code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. Additionally, in some aspects, steps of the methods or algorithms and/or operations may reside as one of codes and/or commands on a machine-readable medium and/or a computer-readable medium, or a certain combination or set thereof.

For a software implementation, the techniques described herein may be implemented with modules (e.g., procedures, functions, and so on) that perform the functions described herein. Software codes may be stored in memory units and executed by processors. The memory units may be implemented within the processors or external to the processors. In this case, the memory units can be connected to the processors by various means so as to communicate therewith.

For a hardware implementation, processing units may be implemented with one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

While specific embodiments of the subject invention have been discussed, the above specification is illustrative and not restrictive. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” and the like are used in the detailed description, claims, appendices and drawings such terms are intended to be inclusive in a manner similar to the term “comprising” as “comprising” is interpreted when employed as a transitional word in a claim.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (such as data from one component interacting with another component in a local system, distributed system, and/or across a network such as the Internet with other systems by way of the signal).

What is claimed is:

1. An idle stop control system comprising:
an information collection unit to collect information about idle stop control of an engine;
a signal processing unit to check whether or not to satisfy a condition of idle stop control based on the information about idle stop control, and to estimate a first cost loss incurred when a start-up state is maintained for an expected time of idle stop, and a second cost loss incurred during restart after the expected time of idle stop; and
an engine control unit to control an idle stop of the engine when the second cost loss is less than the first cost loss.

2. The idle stop control system according to claim 1, wherein the information collection unit comprises at least one of:
a traffic information collection unit to collect traffic information;
a vehicle information collection unit to collect vehicle information; and
an idle stop control condition information collection unit to collect information about the condition of idle stop control.

3. The idle stop control system according to claim 2, wherein the traffic information collection unit comprises at least one of:
a traffic congestion information collection unit to collect traffic congestion information; and
a traffic light information collection unit to collect traffic light information.

4. The idle stop control system according to claim 2, wherein the vehicle information collection unit comprises at least one of:
an engine information collection unit to collect engine information comprising at least one of an engine temperature and fuel consumption during start-up;
a battery information collection unit to collect battery information comprising at least one of a battery replacement cost and the number of times of limited start-up;
a starter motor information collection unit to collect starter motor information comprising at least one of the number of times of limited start-up and a starter motor replacement cost; and
a turn signal information collection unit to collect turn signal information.

5. The idle stop control system according to claim 2, wherein the idle stop control condition information collection unit comprises at least one of:
a brake booster pressure collection unit to collect a brake booster pressure;
a battery charge state collection unit to collect a state of charge of a battery;
an electrical load collection unit to collect an electrical load;
a vehicle speed collection unit to collect a vehicle speed; and
a brake pedal state collection unit to collect a brake pedal state.

6. The idle stop control system according to claim 1, wherein the signal processing unit comprises an idle stop condition determination unit to determine whether to satisfy a condition of idle stop, based on a brake booster pressure, a state of charge of a battery, an electrical load, a vehicle speed, and a brake pedal state.

7. The idle stop control system according to claim 6, wherein the idle stop condition determination unit determines that the condition of idle stop is satisfied when the brake booster pressure is higher than a reference value, when the state of charge of a battery is higher than a reference value, when the electrical load is lower than a reference value, when the vehicle speed is 0 km/h, and when the brake pedal is pressed.

8. The idle stop control system according to claim 1, wherein the signal processing unit comprises a cost estimation unit to estimate an integration cost based on input pieces of information, and
wherein the cost estimation unit comprises at least one of:
a fuel cost estimation unit to estimate a fuel cost based on at least one of an engine temperature and fuel consumption during start-up;
a battery cost estimation unit to estimate a battery cost based on at least one of a battery replacement cost and the number of times of limited start-up;
a starter motor cost estimation unit to estimate a starter motor cost based on at least one of the number of times of limited start-up and a starter motor replacement cost; and
an engine cost estimation unit to estimate an engine cost based on at least one of an engine stop time, an engine temperature, a torque required to start an engine, and an engine replacement cost.

9. The idle stop control system according to claim 8, wherein the cost estimation unit comprises an idle stop duration estimation unit to estimate a time for which an idle stop is maintained, based on at least one of a turn signal, traffic congestion information, traffic light information, and a distance between a traffic light and a vehicle.

10. The idle stop control system according to claim 9, wherein the cost estimation unit comprises an integration cost estimation unit to estimate an integration cost, based on output from at least one of the fuel cost estimation unit, the battery cost estimation unit, the starter motor cost estimation unit, the engine cost estimation unit, and the idle stop duration estimation unit.

11. The idle stop control system according to claim 1, wherein the signal processing unit estimates the expected time of idle stop by matching one of directions of progress in a turn signal or a navigation system with traffic light information.

12. The idle stop control system according to claim 1, wherein when one of directions of progress in a turn signal or a navigation system indicates a right-turn, the signal processing unit does not control the idle stop.

13. The idle stop control system according to claim 1, wherein when one of directions of progress in a turn signal or a navigation system indicates a left-turn, the signal processing unit estimates the expected time of idle stop on the basis of a short one of times required to make left- and U-turns.

14. The idle stop control system according to claim 1, wherein the signal processing unit increases the expected time of idle stop when there is heavy traffic.

15. The idle stop control system according to claim 1, wherein the signal processing unit increases the expected time of idle stop in proportion to a distance between a traffic light and a vehicle.

16. An idle stop control method comprising:
checking whether to satisfy a condition of idle stop control;
collecting information about idle stop control;
estimating cost efficiency for an expected time of idle stop;
checking whether a cost-benefit is present during an idle stop; and
controlling an idle stop of an engine only when the cost-benefit is present.

17. The idle stop control method according to claim 16, comprising:
estimating a first cost loss incurred when a start-up state is maintained for the expected time of idle stop, and a second cost loss incurred during restart after the expected time of idle stop; and
controlling the idle stop of the engine when the second cost loss is less than the first cost loss.

18. The idle stop control method according to claim 17, comprising estimating the expected time of idle stop, based on at least one of a turn signal, traffic congestion information, traffic light information, and a distance between a traffic light and a vehicle.

19. The idle stop control method according to claim 18, comprising:
estimating the expected time of idle stop by matching one of directions of progress in the turn signal or a navigation system with the traffic light information; or
estimating the expected time of idle stop on the basis of a short one of times required to make left- and U-turns, when one of the directions of progress in the turn signal or the navigation system indicates a left-turn.

20. The idle stop control method according to claim 17, comprising:
estimating a fuel cost based on at least one of an engine temperature and fuel consumption during start-up;
estimating a battery cost based on at least one of a battery replacement cost and the number of times of limited start-up;
estimating a starter motor cost based on at least one of the number of times of limited start-up and a starter motor replacement cost; and
estimating an engine cost based on at least one of an engine stop time, an engine temperature, a torque required to start an engine, and an engine replacement cost.
